(19) United States
(12) Patent Application Publication
(10) Pub. No.: US 2005/0027541 A1
(43) Pub. Date: Feb. 3, 2005

(54) System and Method for Fabricating Informational Placard

(76) Inventor: Glen Hagood, Pflugerville, TX (US)

Correspondence Address: TAYLOR RUSSELL & RUSSELL, P.C., 4807 SPICEWOOD SPRINGS ROAD, BUILDING TWO SUITE 250, AUSTIN, TX, 78759, US

(21) Appl. No.: 10/604,577

(22) Filed: Jul. 31, 2003

(51) Int. Cl. G06F 17/60

(52) U.S. Cl. 705/1

(57) ABSTRACT

A computer augmented system and method for fabricating informational placards that may be used in applications such as temporary license plates or tags, or handicap parking placards. The placards are configurable to meet the requirements of various state and other regulatory agencies, and are typically displayed in a prominent location of a motor vehicle. The system comprises a computer system having a user interface, a barcode scanner, access to one or more databases, and a suitable printer for imprinting transparent labels. The transparent labels produced by the printer are affixed to substrates using a suitable adhesive to form placards that are positioned on a motor vehicle for displaying information. The method comprises entering information into a computer system and accessing information from a suitable database, entering or barcode scanning vehicle identification numbers, printing transparent labels, and affixing the transparent labels to substrates to form informational placards for placement on vehicles.

### BACKGROUND OF INVENTION

The invention relates generally to the field of informational display, and particularly to placards for displaying information available to the general public. More particularly, the invention provides for informational placards that meet the requirements of regulatory agencies such as state motor vehicle and public safety agencies. Although the present invention is described in terms of primarily temporary motor vehicle registration placards, its application is considerably broader in scope and application.

Most states have agencies that regulate the manner in which information is displayed on certain placards, such as temporary motor vehicle license plates or tags, and handicap parking tags. The size, type and placement of information contained on these placards is regulated to ensure it is easily and unambiguously discernable by law enforcement officials. The information may be fixed and variable. Generally, the most prominent variable information displayed is the expiration date of the placard. For temporary placards, the expiration date of the placard is most often designated as being between two and four weeks from the date of issue of the placard. For motor vehicles, the expiration date allows sufficient time for a purchaser of a vehicle from a dealer to register the motor vehicle and obtain non-temporary license plates. Other variable information may be vehicle make, purchaser's name, vehicle identification number (VIN), name of a sales person, and data of issue. Fixed information may be preprinted on a placard as a template, such as a dealer's name, address and number, duration of validity of the placard, and designated use, such as for motor vehicles.

Although there may be stringent requirements for the placement of information on placards, the placement of the information is usually not strictly enforced as long as some expiration date is identifiable. Since the information on many placards is created by a salesperson using a felt-tipped pen, the placard information may not comply with requirements in information size, type, placement or accuracy. In some cases, the information on a placard may be incomplete. In addition, hand printed characters on a placard may not present a desired commercially professional image for a dealer whose name appears on the placard.

In motor vehicle applications, temporary license placards are positioned in a rear window or in a license plate holder. Placement in a rear window oftentimes creates a problem of visibility where a rear window is darkly tinted to reduce entry of excessive sunlight. It is sometimes difficult to discern regulatory required colored characters on a placard positioned in a tinted rear window. When positioned in a license plate holder, a temporary placard is subjected to conditions found on roadways, including sun, rain, snow, dirt and wind. Since many of these placards are of paper or cardboard construction, these conditions can render some temporary placards distorted and unreadable within a short time.

A prior method for alleviating these environmental related problems has been to hand print the necessary characters on a placard of paper or cardboard and cover the printed characters with transparent film. This approach has proved to be unsuccessful for several reasons. Although the effects of roadway conditions were reduced, they were not eliminated because the characters were printed on materials of paper or cardboard that are readily soluble in water. In addition, the problems of incorrect or incomplete information hand printed on the placards by dealers have not been addressed.

### SUMMARY OF INVENTION

The present invention provides a system and method for fabricating informational placards that are able to tolerate severe roadway conditions without discernable deterioration prior to the expiration date. It also provides placards that comply with regulatory requirements in terms of information size, type, placement, completeness and accuracy. Because of the high quality of the printed characters on the placard according to the present invention, the image associated with the placard is commercially professional.

The present invention is a system and method for fabricating informational placards that results in a regulatory compliant placard easily positioned on an appropriate vehicle for display of temporary registration expiration. The finished placard comprises a preprinted substrate with fixed information and a transparent label imprinted with variable information. When the transparent label is affixed to the preprinted substrate, the resultant placard contains all information required to comply with jurisdictional regulatory requirements. A computer-augmented method comprises a software program having capabilities for identifying a salesperson responsible for closing a purchase transaction, accepting a purchaser's name from a user interface and reading a vehicle identification number (VIN) of a newly purchased vehicle. The software program determines an expiration date for the temporary vehicle placard based on the current date, accesses detailed vehicle information from a database based in the VIN, and then causes the variable information comprising a current date, an expiration date, VIN, vehicle model year, vehicle make, vehicle model, vehicle purchaser name and salesperson name to be printed on the transparent label. The transparent label is capable of being affixed to a preprinted substrate that is then mounted in a vehicle license plate holder or made clearly visible in vehicle rear window.

The VIN may be keyed in or barcode scanned to improve accuracy and speed. The salesperson may be selected from a list of salespersons employed by a motor vehicle dealer. The VIN is validated against a VIN database where the vehicle model year, vehicle make and vehicle model may be extracted. A purchaser's name may be manually keyed in and a salesperson's name may be keyed in or selected from a database list available to the software. The software then causes the required information to be sent to a printer where the information is printed on the transparent label. The transparent label comprises an optically transparent film having a permanent clear self-adhesive on one side and a glossy clear finish on the opposite side where variable information is imprinted. The transparent label is capable of being affixed to many different kinds of substrate surfaces, including a preprinted cardboard or paper substrate under an application temperature of at least 40° F., and has a service range of from −60° F. to 200° F. Since the printed variable information may be produced by a laser printer, the visual quality of the printed variable information may be extremely good. The printed information may also include fixed information such as dealer name, number and location, state of registration, and intended use.

An embodiment of the present invention is a method for fabricating informational placards comprising the steps of entering a name of a license applicant and a licensing agent into a computer system by a user via a user interface for obtaining a license, determining an expiration date of the license based on the current date by the computer system, entering a vehicle identification number into the computer system by the user via the user interface for accessing information on an identified vehicle from a database, accessing information required by regulatory agencies on informational placards from a database by the computer system, printing a transparent label using a printer connected to the computer system, the transparent label containing the license expiration date, vehicle identification number and information required by regulatory agencies, securing the transparent label to a substrate by the user using adhesive means to form an informational placard, and positioning the informational placard on the identified vehicle by the user. The step of entering a name of a license applicant may comprise selecting the name of the license applicant from a list of license applicants presented to the user via the user interface, the list of applicants accessed from a database. The step of entering a name of a licensing agent may comprise selecting the name of the licensing agent from a list of licensing agents presented to the user via the user interface, the list of agents accessed from a database. The step of determining an expiration date may further comprise adding a time duration period of the license determined by regulatory requirements to the current date. The step of entering a vehicle identification number may comprise scanning a bar code representation of the vehicle identification into the computer system using a bar code scanner. The step of accessing information may be selected from the group consisting of accessing a license applicant's driver's permit number, accessing a licensing agent's permit number, accessing a name of a vehicle dealership, accessing a permit number of a vehicle dealership, and accessing a location of a vehicle dealership. The step of printing a transparent label may be selected from the group consisting of printing a transparent label on a laser printer and printing a transparent label on a thermal printer. The step of securing the transparent label to a substrate may comprise positioning the transparent label on a substrate by aligning label printed characters with corresponding character positions imprinted on the substrate and securing the transparent label to the substrate using weatherproof adhesive means. The step of positioning the informational placard may be selected from the group consisting of positioning the informational placard in a license plate holder of the identified vehicle, positioning the informational placard in a window of the identified vehicle, and positioning the informational placard on a bumper of the identified vehicle.

Another embodiment of the present invention is a system for fabricating informational placards comprising a user interface for entering a name of a license applicant and a licensing agent into a computer system by a user for obtaining a license, computer means for determining an expiration date of the license based on the current date, the user interface for entering a vehicle identification number into the computer system by the user for accessing information on an identified vehicle from a database, computer means for accessing information required by regulatory agencies on informational placards from a database, printer means for printing a transparent label using a printer connected to the computer system, the transparent label containing the license expiration date, vehicle identification number and information required by regulatory agencies, user means for securing the transparent label to a substrate using adhesive means to form an informational placard, and user means for positioning the informational placard on the identified vehicle. The system may further comprise the user interface for displaying a list of names of license applicants accessed from a database, a name of a license applicant being selected by the user. The system may further comprise the user interface for displaying a list of names of licensing agents accessed from a database, a name of a licensing agent being selected by the user. The system may further comprise a bar code scanner for scanning a bar code representation of the vehicle identification number into the computer system. The information required on informational placards by regulatory agencies may be selected from the group consisting of a license applicant's driver's permit number, licensing agent's permit number, name of vehicle dealership, vehicle dealership permit number, and location of vehicle dealership. The printer means may be selected from the group consisting of a laser printer and a thermal printer. The substrate material may be selected from the group consisting of paperboard, cardboard, metal and plastic. The substrate may be imprinted with fixed information. The transparent label may be imprinted with fixed and variable information. The transparent label may be imprinted with variable information. The information placard may be selected from the group consisting of a temporary license plate and a disabled parking placard. The formed informational placard may be durable, tamper resistant and weather resistant.

Yet another embodiment of the present invention is a system for fabricating informational placards comprising a computer connected to a user interface, at least one database, a barcode scanner, and a printer, a transparent label imprinted with information by the printer, a substrate for securing the transparent label, the transparent label being adhesively bonded to the substrate forming an informational placard, and a vehicle for displaying the informational placard. The imprinted information on the transparent label may be selected from the group consisting of variable information, and fixed plus variable information. The information displayed on the information placard may conform to regulatory agency requirements. The substrate may contain fixed imprinted information.

### BRIEF DESCRIPTION OF DRAWINGS

These and other features, aspects and advantages of the present invention will become better understood with regard to the following description, appended claims, and accompanying drawings wherein:

FIG. 1 shows a system diagram for fabricating informational placards;

FIG. 2 shows a flow diagram of a method for fabricating informational placards;

FIG. 3 depicts an embodiment of a substrate imprinted with fixed information according to the disclosed invention;

FIG. 4 depicts an embodiment of a transparent label imprinted with variable information according to the disclosed invention;

FIG. 5 depicts an initial step of securing an imprinted transparent label to a substrate; and

FIG. 6 depicts a finished information placard after a final step of folding a top part of the imprinted transparent label over an opposing side of a substrate according to the disclosed invention.

### DETAILED DESCRIPTION

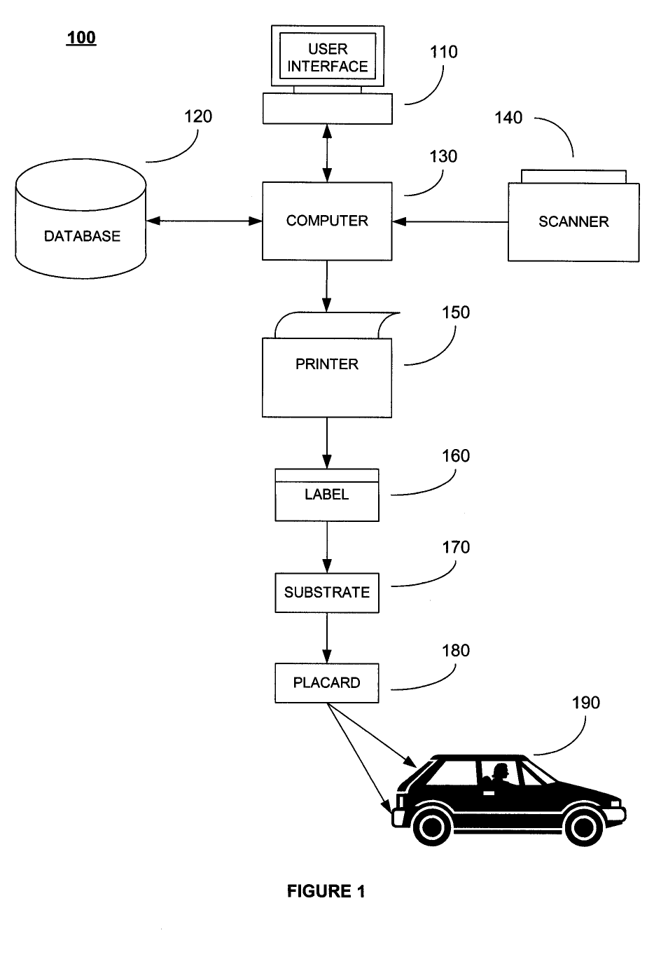

Turning now to FIG. 1, FIG. 1 shows a system diagram 100 for fabricating informational placards. It is a hardware/software solution for filling out temporary license plates, disabled parking placards or other permits that are issued on behalf of governing authority or state by automobile dealers or agents of the governing authority or state. A user interface 110 is connected to a computer 130 for selecting a vehicle salesperson or licensing agent responsible for issuing a placard and for entering a customer's or license applicant's name into the system. A VIN may also be entered into the system via the user interface 110, or may be scanned as a barcode into the system using a barcode scanner 140. The computer 130 uses the VIN to access a database 120 containing vehicle information identified by the VIN. The computer 130 causes a printer 150 to print variable information on a transparent label 160 in a predefined format, determined by a regulatory agency. The printer may be a laser printer or a thermal printer. The transparent label material used with a laser printer may be optically clear polyester having a glossy clear face stock with permanent self-adhesive backing. The printed result from a laser printer are water, solvent and scuff resistant, suitable for indoor and short-term outdoor applications. The adhesive may be a clear acrylic adaptable to many surfaces with a minimum application temperature of 40° F. and a service temperature range of from −60° F. to 200° F. The transparent label material used with a thermal printer may be a glossy clear polystyrene treated for thermal transfer printing, while the adhesive is a general-purpose permanent hot melt rubber base adhesive having a minimum application temperature of 25° F. and a service temperature range of from −65° F. to 150° F. The ink used with the thermal printing process has superior chemical and heat resistant properties as well as superior print quality. The variable data printed on the transparent label may vary from one jurisdiction to another, and is determined by the governing authority or state. This information may be keyed in, scanned in, or extracted from an existing database. The printed information may include information required by regulatory agencies, such as the salesperson's or licensing agent's name, the purchaser's or license applicant's name, motor vehicle information and VIN, and expiration date. The imprinted transparent label 160 is affixed to a substrate 170 containing preprinted fixed information using a suitable adhesive to form a placard 180. The substrate is oftentimes an imprinted cardboard material furnished by a governing authority or state to an agent, but may also be purchased directly from a printing company that is licensed by the governing authority or state. Other substrate material may include paperboard, plastic or metal. The fixed information may include locations designated for motor vehicle name, number and location, state designation and duration of validation of the placard. The informational placard may be positioned on a window, bumper or license plate holder of a vehicle 190. The temporary permit or informational placard is issued to a motorist for a short period of time, typically for a month or less, while the motorist awaits permanent license plates to be issued. Temporary informational placards may also be issued for moving an unlicensed motor vehicle from one location to another.

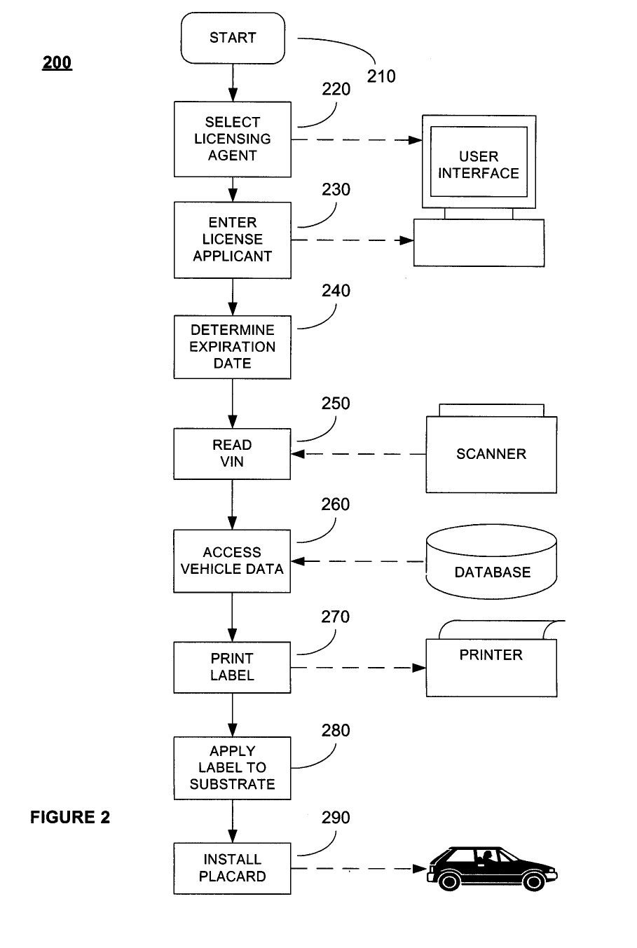

Turning now to FIG. 2, FIG. 2 shows a flow diagram 200 of a method for fabricating informational placards. Once the method is started 210, a salesperson responsible for a sale of a motor vehicle or a licensing agent is selected or entered into the system 220 via a user interface. A name of a purchaser of the motor vehicle or license applicant is also entered into the system 230. The system automatically determines an expiration date 240 based on a current date and the period of validity of the informational placard. A VIN is either entered or barcode scanned into the system 250 enabling vehicle data to be accessed 260 from a database containing vehicle data. Variable information is the printed on a transparent label 270, and may include the salesperson's or licensing agent's name, purchaser's or license applicant's name, placard expiration date, vehicle information and VIN. The imprinted transparent label is then affixed to a substrate 280 using a suitable adhesive to form an informational placard. The informational placard is then installed on a vehicle 290.

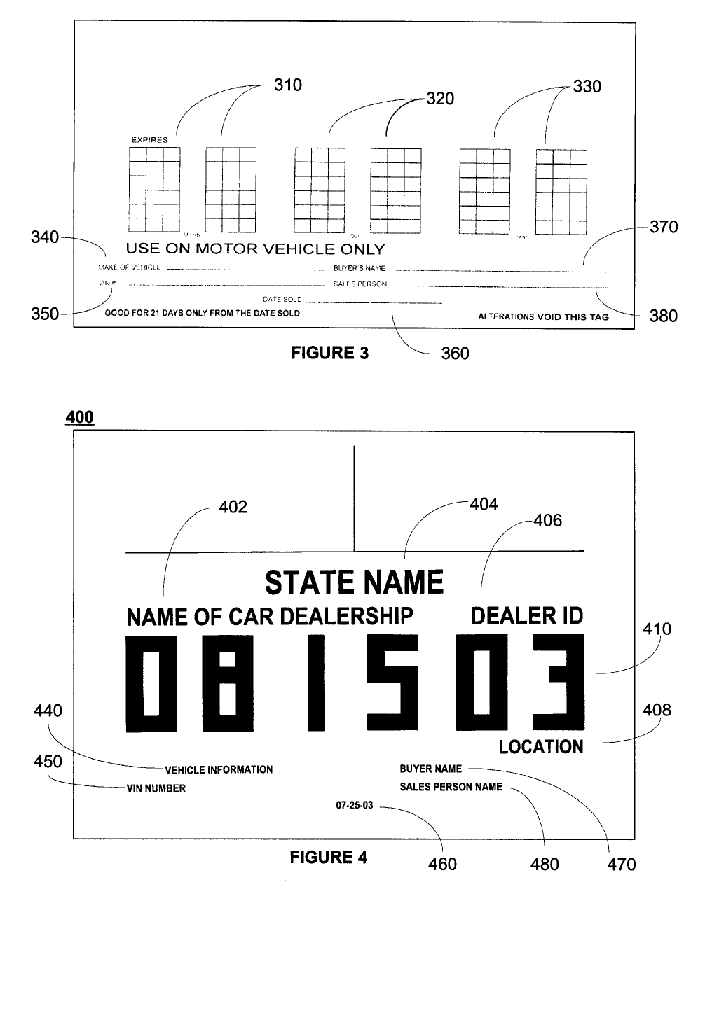

Turning now to FIG. 3, FIG. 3 depicts an embodiment of a substrate 300 imprinted with fixed information according to the disclosed invention. Locations are provided on the substrate for displaying required placard information. The dominant information to be displayed on the substrate is a six-digit expiration date comprising a numeric month designation 310, a numeric day-of-the-month designation 320 and a numeric year designation 330. Locations for other information to be displayed may include make of vehicle 340, VIN 350, date the license was issued or vehicle sold 360, the buyer's or applicant's name 370, and the salesperson's or licensing agent's name.

Turning to FIG. 4, FIG. 4 depicts an embodiment of a transparent label 400 imprinted with variable information according to the disclosed invention. The variable information may include a state name 404, a name of a car dealership 402, a dealer identification number 406, a six digit expiration date 410 as described in relation to FIG. 3 above, specific vehicle information 440, a VIN 450, a vehicle purchase date or license issue date 460, a purchaser's or license applicant's name 470, a salesperson's or licensing agent's name 480, and a dealer or agent location 408.

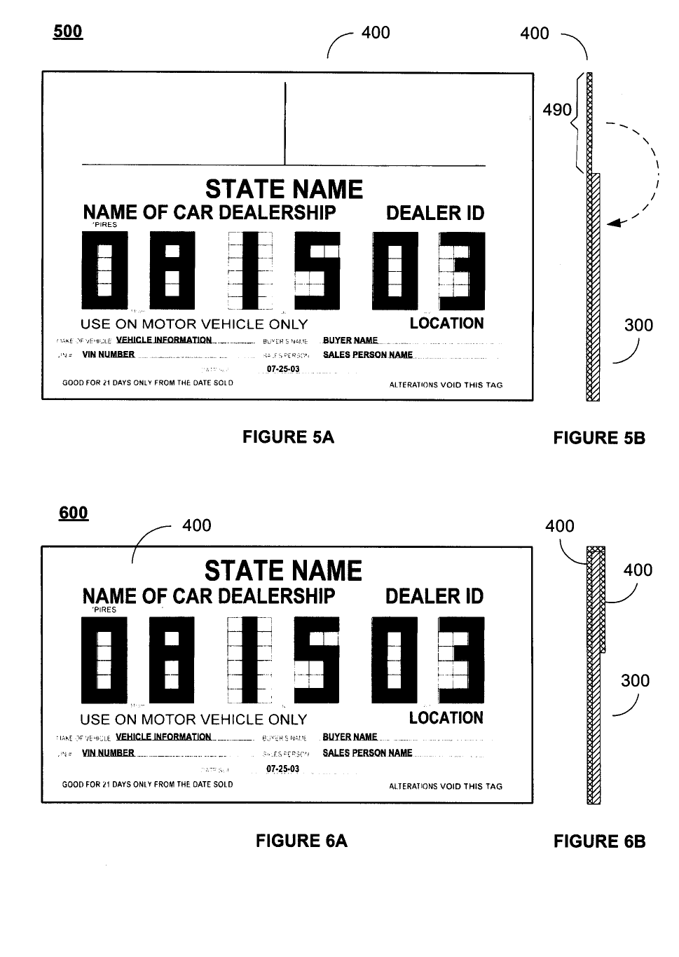

Turning to FIG. 5, FIG. 5A and FIG. 5B depict an initial step 500 of securing an imprinted transparent label 400 to an imprinted front side of a substrate 300. The imprinted transparent label 400 containing variable information is adhered to the imprinted substrate 300 containing fixed information using a suitable adhesive. Care must be taken to align the information locations provided on the front imprinted substrate 300 with the variable information imprinted on the transparent label 400. Once the imprinted transparent label 400 is securely positioned to the front imprinted side of the substrate 300, as shown in FIG. 5A, a top part 490 of the transparent label 400 is folded over a top and backside of the substrate 300, as indicated by the broken circular arrow shown in FIG. 5B.

Turning to FIG. 6, FIG. 6A and FIG. 6B depict a finished information placard 600 after a final step of folding a top part 490 of the imprinted transparent label 400 over an opposing side of a substrate 300 according to the disclosed invention. As indicated in FIG. 6A, the imprinted information on the transparent label 400 and the imprinted information on the imprinted substrate 400 is clearly visible on the front side of the placard 600. FIG. 6B depicts the top part 490 of the transparent label 400 folded over a top part of the substrate 300 and adhered to the back of the substrate 300.

Although the present invention has been described in detail with reference to certain preferred embodiments, it should be apparent that modifications and adaptations to those embodiments might occur to persons skilled in the art without departing from the spirit and scope of the present invention.

1. A method for fabricating informational placards, comprising the steps of:
entering a name of a license applicant and a licensing agent into a computer system by a user via a user interface for obtaining a license;
determining an expiration date of the license based on the current date by the computer system;
entering a vehicle identification number into the computer system by the user via the user interface for accessing information on an identified vehicle from a database;
accessing information required by regulatory agencies on informational placards from a database by the computer system;
printing a transparent label using a printer connected to the computer system, the transparent label containing the license expiration date, vehicle identification number and information required by regulatory agencies;
securing the transparent label to a substrate by the user using adhesive means to form an informational placard; and positioning the informational placard on the identified vehicle by the user.

2. The method of claim 1, wherein the step of entering a name of a license applicant comprises selecting the name of the license applicant from a list of license applicants presented to the user via the user interface, the list of applicants accessed from a database.

3. The method of claim 1, wherein the step of entering a name of a licensing agent comprises selecting the name of the licensing agent from a list of licensing agents presented to the user via the user interface, the list of agents accessed from a database.

4. The method of claim 1, wherein the step of determining an expiration date further comprises adding a time duration period of the license determined by regulatory requirements to the current date.

5. The method of claim 1, wherein the step of entering a vehicle identification number comprises scanning a bar code representation of the vehicle identification into the computer system using a bar code scanner.

6. The method of claim 1, wherein the step of accessing information is selected from the group consisting of accessing a license applicant's driver's permit number, accessing a licensing agent's permit number, accessing a name of a vehicle dealership, accessing a permit number of a vehicle dealership, and accessing a location of a vehicle dealership.

7. The method of claim 1, wherein the step of printing a transparent label is selected from the group consisting of printing a transparent label on a laser printer and printing a transparent label on a thermal printer.

8. The method of claim 1, wherein the step of securing the transparent label to a substrate comprises positioning the transparent label on a substrate by aligning label printed characters with corresponding character positions imprinted on the substrate and securing the transparent label to the substrate using weatherproof adhesive means.

9. The method of claim 1, wherein the step of positioning the informational placard is selected from the group consisting of positioning the informational placard in a license plate holder of the identified vehicle, positioning the informational placard in a window of the identified vehicle, and positioning the informational placard on a bumper of the identified vehicle.

10. A system for fabricating informational placards, comprising:
a user interface for entering a name of a license applicant and a licensing agent into a computer system by a user for obtaining a license;
computer means for determining an expiration date of the license based on the current date;
the user interface for entering a vehicle identification number into the computer system by the user for accessing information on an identified vehicle from a database;
computer means for accessing information required by regulatory agencies on informational placards from a database;
printer means for printing a transparent label using a printer connected to the computer system, the transparent label containing the license expiration date, vehicle identification number and information required by regulatory agencies;
user means for securing the transparent label to a substrate using adhesive means to form an informational placard; and
user means for positioning the informational placard on the identified vehicle.

11. The system of claim 10, further comprising the user interface for displaying a list of names of license applicants accessed from a database, a name of a license applicant being selected by the user.

12. The system of claim 10, further comprising the user interface for displaying a list of names of licensing agents accessed from a database, a name of a licensing agent being selected by the user.

13. The system of claim 10, further comprising a bar code scanner for scanning a bar code representation of the vehicle identification number into the computer system.

14. The system of claim 10, wherein the information required on informational placards by regulatory agencies is selected from the group consisting of a license applicant's driver's permit number, licensing agent's permit number, name of vehicle dealership, vehicle dealership permit number, and location of vehicle dealership.

15. The system of claim 10, wherein the printer means is selected from the group consisting of a laser printer and a thermal printer.

16. The system of claim 10, wherein the substrate material is selected from the group consisting of paperboard, cardboard, metal and plastic.

17. The system of claim 10, wherein the substrate is imprinted with fixed information.

18. The system of claim 10, wherein the transparent label is imprinted with fixed and variable information.

19. The system of claim 10, wherein the transparent label is imprinted with variable information.

20. The system of claim 10, wherein the information placard is selected from the group consisting of a temporary license plate and a disabled parking placard.

21. The system of claim 10, wherein the formed informational placard is durable, tamper resistant and weather resistant.

22. A system for fabricating informational placards, comprising:
a computer connected to a user interface, at least one database, a barcode scanner, and a printer;
a transparent label imprinted with information by the printer;
a substrate for securing the transparent label;
the transparent label being adhesively bonded to the substrate forming an informational placard; and
a vehicle for displaying the informational placard.

23. The system of claim 22, wherein the imprinted information on the transparent label is selected from the group consisting of variable information, and fixed plus variable information.

24. The system of claim 22, wherein the information displayed on the information placard conforms to regulatory agency requirements.

25. The system of claim 22, wherein the substrate contains fixed imprinted information.
